(19) United States
(12) Patent Application Publication
(10) Pub. No.: US 2017/0116547 A1
(43) Pub. Date: Apr. 27, 2017

(54) TICKET VALIDATION SYSTEM AND METHOD

(71) Applicant: International Business Machines Corporation, Armonk, NY (US)

(72) Inventors: Doina L. Klinger, Winchester (GB); Christine Osbourn, Timsbury (GB); Rebecca M. Quaggin-Mitchell, Botley (GB); Fenglian Xu, Knightwood (GB)

(21) Appl. No.: 14/922,392

(22) Filed: Oct. 26, 2015

(51) Int. Cl. G06Q 10/02; G07B 11/00

(52) U.S. Cl. CPC G06Q 10/02; G07B 11/00

(57) ABSTRACT

Aspects of the present invention disclose a method, computer program product, and system for ticket validation. The method includes one or more processors receiving ticket identification information corresponding to a transportation ticket and vehicle identification information corresponding to a transportation vehicle, wherein the transportation vehicle is associated with a transportation route. The method further includes retrieving a first data entry corresponding to the received ticket identification information. The method further includes retrieving a second data entry corresponding to the received vehicle identification information. The method further includes determining whether the transportation ticket is valid for travel along the transportation route associated with the transportation vehicle based on the retrieved first data entry and the retrieved second data entry. The method further includes generating an output signal that provides an indication of whether the transportation ticket is valid for travel along the transportation route associated with the transportation vehicle.

### BACKGROUND OF THE INVENTION

The present invention relates to a system and method for providing ticket validation information to a passenger of a public transport system. The present invention further relates to a ticketing system for determining ticket validation information for conveyance to a passenger of a public transport system.

Databases and/or systems are available that contain real-time travel information pertaining to a particular public transit system, where this information may include live information relating to transit vehicle routing and route scheduling. The database or system may be accessible to passengers of the transit system (e.g., via a mobile communication device), thereby enabling passengers to search for real-time information concerning the routing or timings of their present or intended journey.

Computerized ticket validation systems are available for use in association with a platform barrier system, in which public transport tickets may be scanned to identify ticket information, and a barrier to a platform either opened or held closed depending upon an assessment made by the ticket validation system as to the validity of the ticket for access to the given platform.

### SUMMARY

Aspects of the present invention disclose a method, computer program product, and system for ticket validation. The method includes one or more processors receiving ticket identification information that corresponds to a transportation ticket and vehicle identification information that corresponds to a transportation vehicle, wherein the transportation vehicle is associated with a transportation route. The method further includes one or more processors retrieving a first data entry that corresponds to the received ticket identification information, wherein the retrieved first data entry includes one or more of: a ticket identification element, a journey start location element, a journey end location element, and a journey valid time-period element. The method further includes one or more processors retrieving a second data entry that corresponds to the received vehicle identification information, wherein the retrieved second data entry includes one or more of: information relating to the transportation route associated with the corresponding transportation vehicle, one or more route stop locations along the transportation route, and expected times-of-arrival of the transportation vehicle at the one or more route stop locations. The method further includes one or more processors determining whether the transportation ticket is valid for travel along the transportation route associated with the transportation vehicle based on the retrieved first data entry and the retrieved second data entry. The method further includes one or more processors generating an output signal that provides an indication of whether the transportation ticket is valid for travel along the transportation route associated with the transportation vehicle.

### BRIEF DESCRIPTION OF THE DRAWINGS

Preferred embodiments of the present invention will now be described, by way of example only, with reference to the following drawings.

FIG. 1 is a flow diagram representing a computer implemented method for conveying public transport ticket validation information, in accordance with an embodiment of the present invention.

FIG. 2 is a flow diagram representing a computer implemented method for validating a public transport ticket, in accordance with an embodiment of the present invention.

FIG. 3A depicts an example set of data entries that can be stored within an example second data store, in accordance with an embodiment of the present invention.

FIG. 3B schematically depicts a pictorial representation of transport routes associated with the data entries of FIG. 3A, in accordance with an embodiment of the present invention.

FIG. 4 schematically depicts a functional structure of an example ticketing system 52, in accordance with an embodiment of the present invention.

FIG. 5 schematically depicts a public transport vehicle that includes a ticket validation system for providing ticket validation information, in accordance with an embodiment of the present invention.

FIG. 6 schematically depicts an exemplary structure and operation of an example ticket validation system of a public transport vehicle, in accordance with an embodiment of the present invention.

FIG. 7 depicts a block diagram of components of a computing system capable of performing the computer implemented methods of FIG. 1 and FIG. 2, in accordance with an embodiment of the present invention.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer (i.e., is a computer-implementable method). The various steps of the method therefore reflect various parts of a computer program (e.g., various parts of one or more algorithms).

Aspects of the present invention provide a method for relaying to a user of a public transport system information concerning the validity or invalidity of the user's purchased transport ticket for travel upon a particular vehicle operating within that transport system. The information is provided upon scanning the ticket with a dedicated ticket scanning device of the vehicle, the device can be mounted in the vicinity of an entry or boarding point of the vehicle, thereby allowing use by a passenger directly as the passenger boards the vehicle. Information provided to the passenger relates directly to the particular ticket upon which the passenger is travelling and to the specific vehicle that the passenger is seeking to board.

Ticket information acquired by scanning the ticket may, according to one or more examples, include simply ticket identification information (e.g., a ticket identification number or code), which allows location or retrieval by the ticketing system of a more comprehensive set of associated ticket information from a data store. In alternative examples, the ticket information acquired by scanning the ticket may include a more comprehensive set of ticket information, including, but not limited to, a valid time period for use of the ticket and one or more valid locations for travel by means of the ticket.

The vehicle information output in tandem with the ticket information may likewise, according to one or more embodiments, include simply vehicle identification information, such as a vehicle identification number or code. The vehicle identification information may allow the ticketing system to look-up or retrieve associated route information corresponding to the route assigned to the vehicle at the time of scanning. The route information may, according to one or more non-limiting examples, include information concerning planned stop locations of the vehicle and the expected dates and times of the planned stop locations at the time of scanning. In alternative embodiments, the vehicle information that is output to the ticketing system may include such route information.

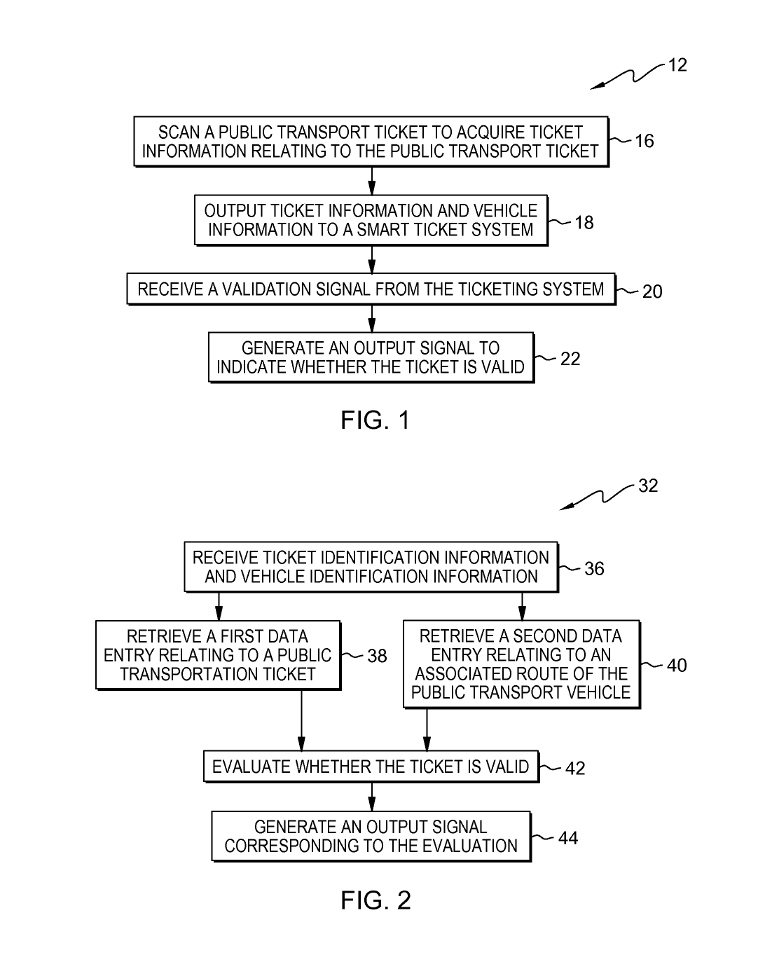

FIG. 1 depicts a flow diagram representing a method 12 for conveying public transport ticket validation information, in accordance with an embodiment of the present invention. The method 12 begins with the process of scanning a public transport ticket (e.g., with a scanner of a public transport vehicle) to acquire ticket information relating to the public transport ticket (step 16). The ticket information may, according to one or more examples, include ticket identification information, such as a ticket identification code or identification number. In other examples, the ticket information may, additionally or alternatively, include information pertaining to the particular locations and/or time periods that are valid for travel using the ticket. For example, the ticket information includes a journey end-point location, a journey start-point location, and/or a valid date and time range for travel using the ticket.

Once the ticket information has been acquired, the method proceeds to the process of outputting ticket information and vehicle information on a smart ticketing system (step 18). In one embodiment, the method 12 outputs the ticket information, in combination with information pertaining to the public transport vehicle on which the scanner is operating, to a ticketing system. The ticketing system can be adapted to receive and process such information. The vehicle information may include vehicle identification information, for instance a vehicle identification number or identification code. In addition, or alternatively, the vehicle information may include information pertaining to a designated route of vehicle. For example, an end-point of the route and intermediate stop locations of the route, as well as for instance scheduled dates and/or times of arrival of the vehicle at those stop locations.

The ticketing system is configured to evaluate, on the basis of the output ticket and vehicle information, whether the ticket which has been scanned is valid for travel along the designated route of the vehicle.

After outputting the ticket and vehicle information to the ticketing system, the method 12 proceeds to the process of receiving a validation signal from the ticketing system (step 20). In example embodiments, the validation signal provides an indication as to the result of the ticket validity evaluation (e.g., whether the ticket is valid or not valid) performed by the system.

After receiving the validation signal, the method 12 includes the process of generating an output signal to indicate whether the ticket is valid. In an example embodiment, method 12 generates the output signal on the basis of the validation signal, which can convey to a passenger of the public transport vehicle an indication as to whether or not the scanned ticket is valid for travel on the vehicle (step 22).

Embodiments of the invention provide a method for providing dynamic, real-time ticket validation information to passengers of a public transit system. The provided information is specific and personally tailored to the particular ticket, which is scanned and to the particular vehicle upon which the ticket scanning device is located. The validation of the ticket is performed on the basis of ticket and vehicle route information that is provided automatically and electronically (e.g., through steps of a computer-implemented process). The automatic and electronic process can provide a reduction in the potential for human error in inputting such information manually. By performing validation through a process of communication with a ticketing system, the method can provide information to the passenger that is both ‘up-to-the-minute’ accurate and entirely specific to the very particular ticket which they have purchased.

In addition, by locating a ticket scanner on the particular vehicle (or associating with a particular vehicle) on which the evaluation of travel validity is occurring, the potential for passenger error in boarding the wrong vehicle can be further reduced. For example, such an arrangement far better guarantees that the vehicle information used in making the evaluation does indeed relate to the very vehicle on which the passenger will be travelling (conditional to the validation information). In contrast, in alternative methods validation information may be provided at some point prior to the boarding of the vehicle, and such examples inherently encompasses some risk that the passenger gets onto the wrong vehicle by mistake.

Such a method may confer particular advantage, for example, in an application within terminals or stations of a busy public transit system serving multiple transit vehicles and associated routes at any one time, and being used by large volumes of passengers. In an example embodiment, at a train station at particularly busy periods, that public information boards may not accurately update in time for the arrival of a given train. Such situations can occur in cases where scheduling and/or platform allocations are changing dynamically and at short notice in response to ongoing events or incidents. In such cases, there is a real risk of passengers mistakenly boarding a train with a corresponding destination or route that is not permitted for travel by means of the passengers ticket.

Such errors are not only an inconvenience to the passenger, who can end up travelling along a route and toward an unintended destination, but may often also result in the incurrence of certain financial costs to the passenger. For example, the passenger may have to pay fines for travelling without a valid ticket, or at least may have to pay for an additional transit ticket to provide the passenger coverage to travel on from the mistaken destination to the actual intended destination.

Such boarding errors also incur costs and inefficiencies for operators of the transit system, since passenger flow cannot be accurately monitored or managed across the system. For example, potentially a significant number of passengers may end up not travelling aboard the vehicles which the passengers are supposed to travel. In the absence of absolute coverage of all vehicles with ticket inspectors, many passengers may end up travelling along journeys for which the passengers have not been required to pay the full cost.

Embodiments of the present invention avoid such difficulties by providing a confirmation of a ticket's validity or invalidity for travel upon a specific vehicle directly upon boarding the vehicle. In these embodiments, the information can be known with a high level of accuracy and confidence at the very moment of boarding, avoiding the possibility that last-minute changes to platform allocations have led to the boarding of an incorrect train.

The method may also be particularly advantageous for application within transport systems that serve large numbers of non-regular passengers of the system (e.g., tourists) who are unacquainted with the scheduling and routing of the different vehicles of the system and may consequently find difficulty in retrieving relevant information through manual processes. Such difficulties can also be compounded in public transport systems where large numbers of passengers have only limited familiarity with the local language. For example, public information boards may be of limited use to many passengers, unless the information boards are specifically adapted to display information in a wide range of differing languages.

In various example embodiments, a multitude of benefits result from a method for conveying relevant ticket validation information to a passenger, which does not rely on a passenger having to extract such information themselves from a broader set of scheduling or routing information: a process which is inherently prone to error—either due to misapprehension by a passenger as to the scope of validity of the passengers ticket, or due to misidentification of the correct transit vehicle to board for travel along a particular scheduled route.

According to one or more examples of the method 12, the process of scanning a public transport ticket may include scanning a physical transport ticket, such as a paper ticket (step 16). In additional embodiments, scanning the ticket may include scanning a barcode or QR code printed on the ticket utilizing of an optical scanning device. Alternatively, scanning a physical ticket may include reading information contained within a magnetic storage element of the ticket (e.g., scanning a magnetic strip provided on the ticket and encoded with ticket information).

In at least some examples, scanning a ticket (in step 16) may alternatively include scanning a variety of electronic tickets, such as a ticket stored within a storage medium of a computing device such as a mobile computing or mobile communication device. Scanning an electronic ticket can include a process of reading or retrieving ticket information stored within the mobile computing or communication device (e.g., through a process of wireless communication with the mobile device). In an example embodiment, the wireless communication can include communication by means of near-field communication technology, a wireless personal area network (WPAN), a mobile internet connection, or any other suitable radio or microwave frequency communication technology.

According to one or more embodiments, scanning the ticket can include reading information contained within a near-field-communication tag of the ticket (e.g., utilizing a near-field-communication RF transceiver element). In such embodiments, the ticket can be a form of electronic ticket, and scanning the ticket can include wirelessly communicating with a near-field-communication transceiver element of a mobile computing or mobile communication device that is held by the passenger. In some embodiments, scanning the ticket may include reading a QR code that is printed on the ticket, or reading a QR code associated with the ticket and displayed (e.g., on the screen of a mobile computing device or mobile communication device).

In various examples, the process of scanning the ticket (step 16) may involve a passenger manually presenting their ticket to a ticket scanning device located on the vehicle. For example, a ticket scanning device situated in the vicinity of an entry or boarding point of the vehicle. Alternatively, a ticket may be scanned through a passive scanning process, in which one or more sensors automatically scan a passenger's ticket as the passenger and the ticket pass into the train (e.g., utilizing a wireless communication technology, such as radio frequency technology).

In another example embodiment, tickets to be scanned can include one or more radio frequency tags storing ticket information. Radio frequency sensors located in the vicinity of entry points of the vehicle may be adapted to communicate with tags of the tickets at relatively long range (e.g. 1-2 m, 2-3 m, 3-4 m, etc.). In this embodiment, a user's ticket may be scanned without any active intervention or action on the part of a passenger. Scanning tickets without intervention can both improve convenience for the passenger—who does not need to find and take out the ticket upon boarding the vehicle—and also helps to avoid congestion at entry points of the train, since passengers would not need to pause at scanning devices to actively scan tickets during the boarding process.

According to one or more examples of the method 12, generating an output signal (step 22) may include triggering the generation of a sensory output signal utilizing a sensory output device.

A sensory output signal can include a visual signal. The visual signal may consist of a signal generated through activation or deactivation of one or more provided lighting elements. For example, a validation signal received from the ticketing system indicating that the scanned ticket is valid for travel might result in the flashing or static activation of a first set one or more lights (e.g., LED light elements or filament light elements) of the scanning device, or positioned in the vicinity of the scanning device. A validation signal received from the ticketing system indicating that the scanned ticket is invalid for travel might result in the flashing or static activation of a second set one or more lights. The first and second set of lights might can include lights of different respective colors, for example green lights to indicate a valid ticket and red lights to indicate an invalid ticket.

In another example, a visual signal may be generated that can at least include the presentation of a written message to the passenger providing an indication of the validity of the ticket. Such a written message can be displayed by means of a display unit either included with the ticket scanning device or located adjacent to or in the vicinity of the scanning device. In examples, the message may be displayed, or be displayable, in a plurality of different languages for instance.

According to some examples, the generated sensory output signal may include an acoustic signal. The acoustic signal may include a beeping or buzzing sound. The acoustic signal may be generated in tandem with one or more visual signals, such as one or more of the flashing or solid light signals as previously described. Alternatively, an acoustic signal may include a spoken message communicating information concerning the validity or invalidity of a ticket. Again, such a spoken message may be provided in combination with an associated visual signal. The visual signal can include a visually displayed version of the message provided acoustically, or alternatively including one or more of the light-based signals, or a different visual signal.

In various embodiments, generating the output signal (step 22) may include generating an electronic communication signal for transmission to a mobile computing device or mobile communication device. For example, generating the output signal can include transmission of an SMS, MMS, or other mobile message to the mobile phone of the passenger that corresponds to the scanned ticket. The mobile message may contain information pertaining to the validity of the scanned ticket. Alternatively, generating the output signal can include the sending of one or more other forms of electronic message, such as an email. In some examples, generating the output signal can include conveying one or more messages to a passenger, via a mobile device, through means of a dedicated application installed on the mobile device. For example, a passenger may have pre-installed a dedicated application on a mobile phone. The application can be configured to control the mobile phone so as to be receptive of a wirelessly transmitted message conveying information pertaining to ticket validity.

In some cases, the generating of the output signal (step 22) can include communicating with a mobile device to generate a sensory output signal from the mobile device, (e.g., a visual signal, an acoustic signal or a kinesthetic signal, such as a vibration).

Advantages of the output signal being generated in association with a mobile device belonging to the passenger include the mitigation of potential congestion at entry points of the vehicle. For example, passengers would not need to pause at the ticket scanning device after scanning a ticket in order to receive the ticket validation information. Rather, a passenger may simply scan the ticket as the passenger passes into the vehicle, and then read or receive validation information on a mobile phone or mobile computing device at a convenient point subsequent to their entry onto the vehicle. Therefore, passengers entering the vehicle are capable of receiving ticket validation information without obstructing the boarding or alighting of other passengers.

FIG. 2 depicts a flow diagram representing a method 32 for validating a public transport ticket, in accordance with an embodiment of the invention. In step 36, the method 32 receives ticket identification information and vehicle identification information. In one embodiment, the received ticket identification information and vehicle identification information relates to a particular public transport ticket and a particular public transport vehicle, where the public transport vehicle is associated with a particular route. The ticket identification information may include a ticket identification code or identification number, and the vehicle identification information may include a vehicle identification code or number.

Once method 32 receives ticket and vehicle identification information, the method next proceeds to the parallel processes of steps 38 and 40. In step 38, method 32 retrieves a first data entry relating to the public transport ticket associated with the received identification information (e.g., from a respective first data store). In step 40, method 32 retrieves a second data entry relating to the associated route of the public transport vehicle that corresponds to the received vehicle identification information (e.g., from a respective second data store).

The first data store stores a plurality of data entries relating to different respective transport tickets The respective data entries within the first data store can include at least one of: a ticket identification element (providing a handle to enable unique look-up of each data entry), a journey start location element, a journey end location element and a journey valid time-period element, etc.

In example embodiments, the journey start location element and/or the journey end location element of each data entry may respectively include information pertaining to the name of a particular location, or may pertain to a unique identifier (e.g., a code or number) associated with a given location. A start or end location may refer to a geographical location, or a relative location or point within a specific public transport system (e.g., a stop or station within the transportation system).

In various examples, the journey valid time-period element may include information pertaining to both valid dates and valid times of travel by means of the ticket. The valid time period element may include a fully enumerated list of specific dates and times for which travel is valid by means of the ticket. In another example, the valid time period element may include one or more extremal dates and/or times, representing boundaries of one or more particular ranges of valid dates and/or times for travel by means of the ticket.

The second data store stores a plurality of data entries relating to different respective routes associated with respective transport vehicles of the public transport system. The data entry can include at least one of: a vehicle identification element (providing a handle to enable unique look-up of each vehicle's associated route-related data entry), and one or more stop location elements and associated stop arrival time elements.

The stop arrival time elements may each relate respectively to an anticipated or scheduled arrival date and/or time of the public transport vehicle at the stop location represented by the associated stop location element.

The stop location elements can include information pertaining to the name, or to a unique identifier (e.g., an identification code or number), of a particular location at which the vehicle is scheduled to stop along a designated route. A stop location may refer to a geographical location, or may refer to a relative location or point within a specific public transport system (e.g., a stop or station within that system). In various embodiments, the stop location elements may include a starting location of the route, an end (or destination) location of the route, and any intermediate stop locations between the starting location and the ending location.

In step 42, the method 32 compares the retrieved first and second data entries to evaluate whether the ticket is valid for the route. In one embodiment, the method 32 evaluates whether the public transport ticket that corresponds to the first data entry valid for travel along the route that corresponds to the second data entry. The evaluation allows method 42 to establish whether the public transport ticket is valid for travel upon the particular vehicle.

In response to completing step 42, the method 32 performs the process of generating an output signal corresponding to the result of the evaluation (step 44). According to one or more embodiments, the evaluation of ticket validity may include comparing the journey valid time-period element of the first data entry with one or more stop arrival time elements of the second data entry. Method 32 can utilize the comparison to establish whether the expected arrival times of the vehicle at one or more planned stop locations coincide with the particular time period over which the passenger's ticket is valid for travel.

Furthermore, according to example embodiments, the evaluation of ticket validity may include comparing the first and second data entries to determine whether the journey end location element of the first data entry corresponds to any of the one or more journey stop location elements of the second data entry. Method 32 can utilize this comparison to determine whether or not the planned route of the vehicle enables the passenger to travel directly to the destination location (i.e., whether the vehicle is due to stop at the end location to which their ticket provides the passenger valid permission to travel).

In certain embodiments, the evaluating can also include searching data entries of the second data store to establish whether the data store includes a further set of entries that are associated with a set of further vehicles, and the corresponding routes that can allow a valid journey from a journey start point associated with the ticket to a journey end point associated with the ticket, within the valid time period associated with the ticket. In this embodiment, the method 32 can determine whether an indirect route exists to the passenger's journey destination (i.e. the journey end location associated with the ticket). At least a portion of the indirect route can be served by the planned route of the currently boarded vehicle. If such further data entries do exist, the evaluation may return a positive validity result, indicating that the ticket is valid for travel aboard the given vehicle at that time and given the present location of the vehicle. In example embodiments, the method 32 can output the results of the determination, which can include information relating to the particular stops populating any such indirect journey, as well as optionally the scheduled arrival times of the vehicle at those stops (in step 44).

In particular, the method 32 can also output (in step 44) information pertaining to the particular stop location at which a passenger intends to alight from the currently boarded vehicle in order to correctly complete the indirect journey (the ‘change-over’ stop). In addition, the method 32 can also output (in step 44) the scheduled arrival time at the changeover stop of the further vehicle (associated with a respective one of the one or more further data entries) that the passenger can utilize to continue the indirect journey.

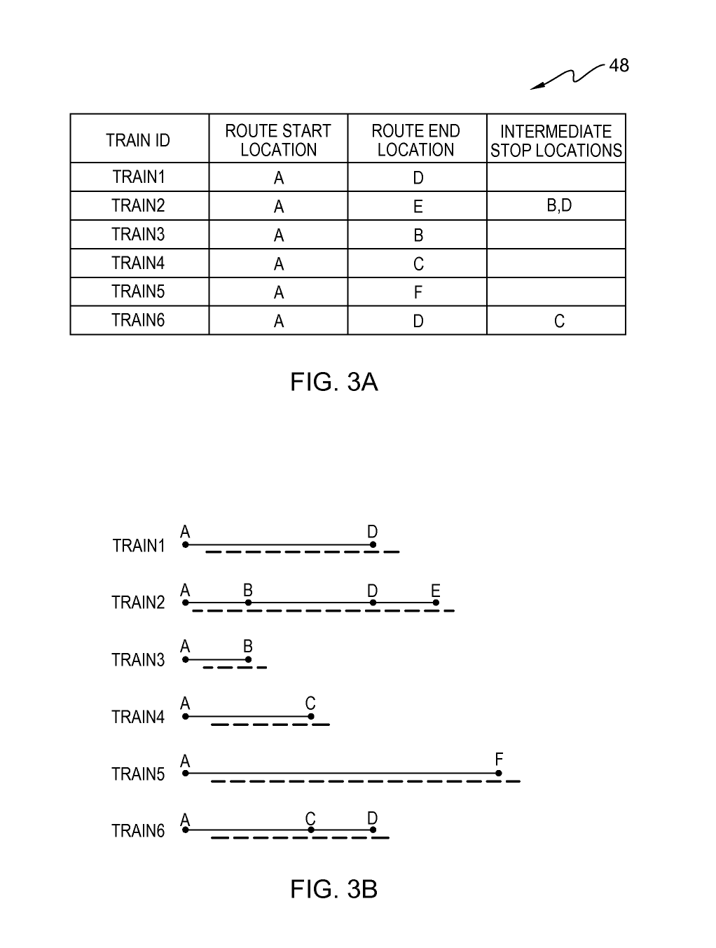

By way of an illustration, FIG. 3A depicts table 48, which presents a representation of an example set of data entries that can be stored within an example second data store. In the depicted example embodiment, table 48 pertains to routes associated with trains of a train system. Table 48 lists train identification (ID) names, route start locations, route end locations, and intermediate stop locations for each of six different trains. Route start location, route end location, and intermediate stop locations are represented in table 38 by lettered codes A-F.

FIG. 3B is a schematic depiction of a pictorial representation of the respective routes represented by the data entries listed in table 48 (FIG. 3A).

In an example embodiment, consider a passenger that has purchased a ticket that permits the passenger valid travel from location A to location D. In this case, the validity evaluation (in step 42) of the method 32 may include a sub-step of determining whether the journey end location associated with the ticket—and stored as part of the first data entry retrieved in step 38—corresponds to any of the route stop locations associated with the vehicle route—these being stored as part of the second data entry retrieved in step 40.

In the case for example that the vehicle identification information received in step 36 relates to Train1 of Table 48 and FIG. 3B, method 32 can utilize the sub-step to return a positive result, since the route assigned to Train1 includes a stop location (D) that matches the journey end location of the passenger ticket (e.g., the stop location is the terminus or end location of the vehicle route). According to this first example, the method 32 can then simply generate an output signal (in step 44) indicating that the ticket related to the first data entry is valid for travel along the route related to the second data entry.

In another example embodiment, the vehicle identification information relates to Train3, in which case the method 32 can utilize the sub-step (referred to above) to return a negative result, since the stop locations of Train3 do not include stop D. In this example embodiment, the evaluating (in step 42) of the method 32 may further include one or more additional sub-steps to determine whether the second data store (e.g., utilizing data entries listed in table 48) includes one or more further data entries corresponding to routes that can allow, in combination with at least a portion of the route of Train3, a valid journey to the journey end location of the passenger ticket.

In various embodiments, such a further sub-step would produce a positive result, since the system includes a train having respective stop locations that coincide both with a stop location of Train3 and with the journey end location of the passenger ticket (location D). For example, Train2 stops at both location B (the route end location of Train3) and at stop D (the journey end location of the passenger ticket). According to this example, the method 32 includes generating an output signal indicating that the ticket corresponding to the ticket identification information is valid for travel on the vehicle corresponding to the vehicle identification information (in step 44).

Furthermore, according to one or more embodiments, the method 32 can further include generating an output signal (in step 44) that, in addition to the ticket validity indication, provides information pertaining to the particular stop location (in this case location B) at which a passenger travelling aboard Train3 with the given ticket must alight in order to complete a valid journey to the journey end location assigned to the ticket. In an additional example, the output signal can further include information pertaining to the scheduled arrival or departure time of Train2 at or from stop location B.

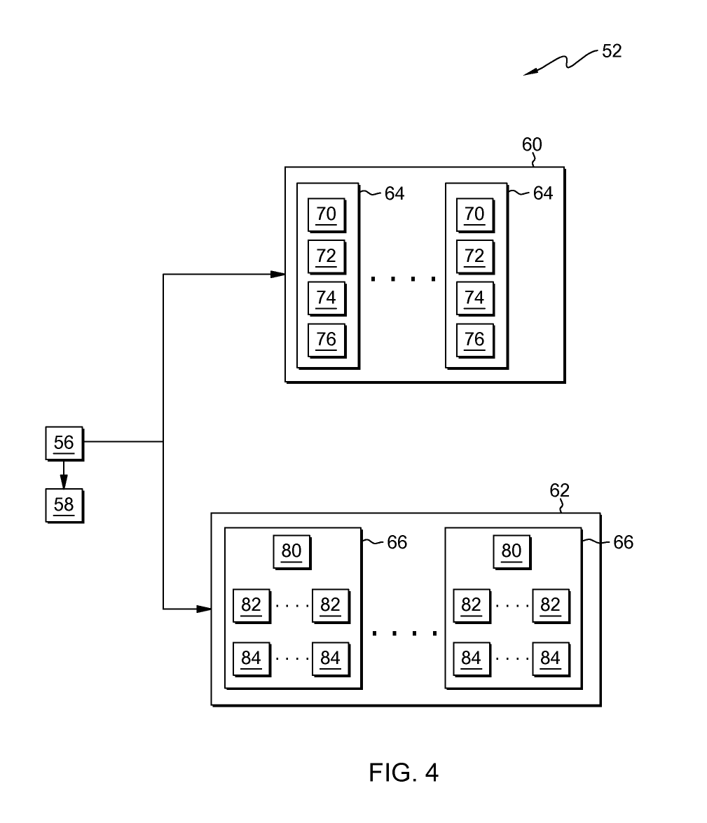

FIG. 4 is a schematic depiction of a functional structure of an example ticketing system 52, in accordance with an embodiment of the invention. In example embodiments, the ticketing system 52 may be adapted to implement embodiments of the method for validating public transport tickets (i.e., method 32, as depicted in FIG. 2 and described in the preceding paragraphs).

The example ticketing system 52 includes a processor 56, operatively coupled to a computer readable storage medium 58. The computer readable storage medium 58 may embody program instructions that are executable by the processor 56, and which cause the processor, on execution, to carry out the steps of method 32 (depicted in FIG. 2) for ticket validation.

The ticketing system further includes first data store 60 and second data store 62, each storing a plurality of data entries (e.g., data entries 64 and 66) that can respectively contain public transport ticket information and public transport vehicle route information.

The first data store 60 includes a plurality of data entries 64, each respectively relating to a particular public transport ticket. Each instance of data entries 64 can include four data elements: a ticket identification element 70, a journey start location element 72, a journey end location element 74, and a journey valid time-period element 76.

The second data store includes a plurality of data entries 66, each respectively relating to an associated route of a particular public transport vehicle. Each instance of data entries 66 can include a vehicle identification element 80, a plurality of route stop location elements 82, and an associated plurality of stop arrival time elements 84.

In example embodiments, the ticketing system 52 may operatively interact with one or more ticket purchasing systems, such as a station ticket purchasing system or an online ticket purchasing system. The interaction can allow the new data entries of the first data store 60 to be generated in response to each new purchase of a ticket by a passenger. For example, a passenger may make use of a dedicated website or mobile computing application to purchase a ticket for a journey. On purchasing the ticket, a new data entry may be added automatically to the first data store 60 of the ticketing system 52. The new data entry can contain information pertaining to the valid locations and times permitted for travel by means of the purchased ticket. In this example, the ticketing system can provide up-to-the-minute verification information in relation to a given passenger's purchased ticket and to a given transport vehicle upon which a passenger is attempting to travel.

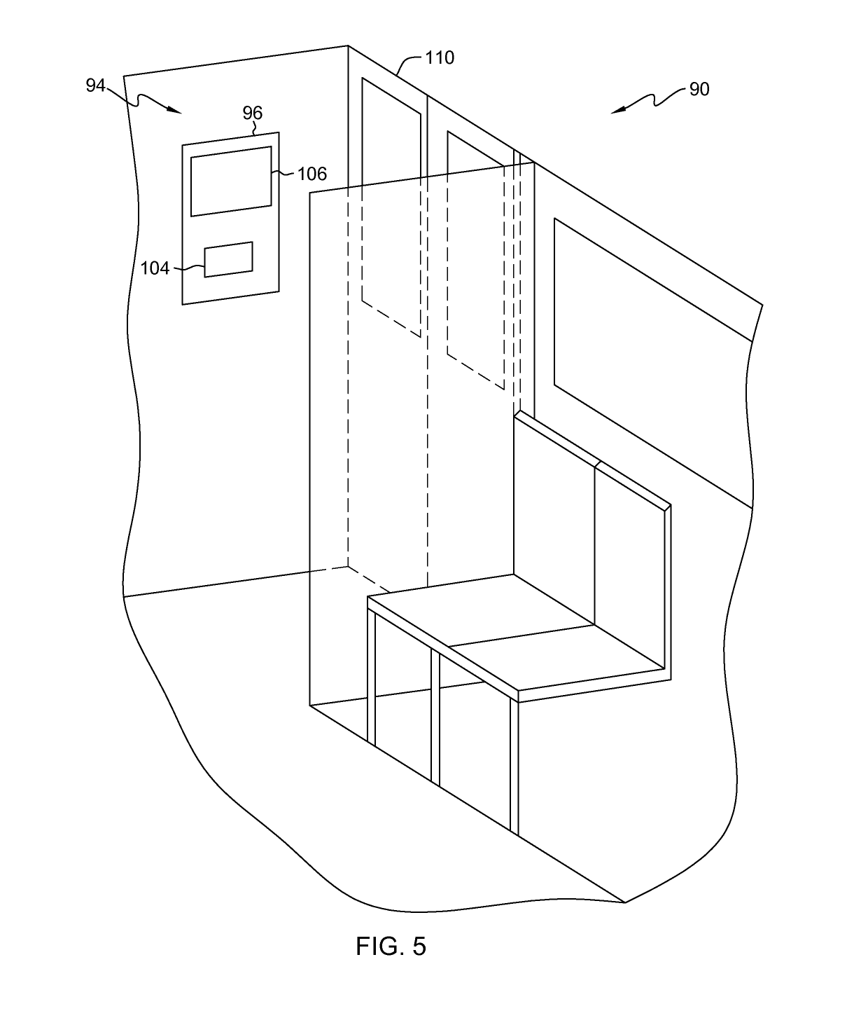

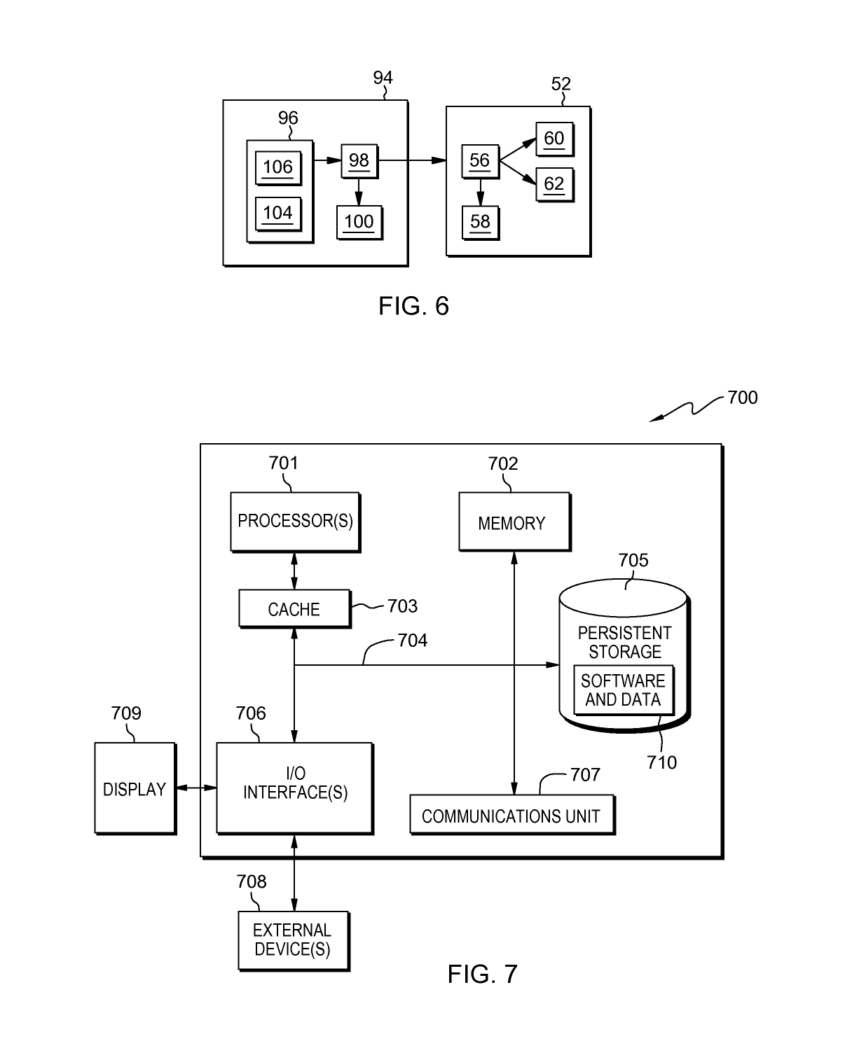

FIG. 5 schematically depicts an example public transport vehicle 90, which includes a ticket validation system 94 for providing ticket validation information, in accordance with an embodiment of the invention. The structural and functional arrangement of the ticket validation system 94 is shown in greater detail in FIG. 6. For the purposes of this example, the ticket validation system includes a ticket scanning device 96 and operatively coupled processor 98 and computer readable storage medium 100.

In one or more examples, the computer readable storage medium 100 may include embodied program instructions, the program instructions executable by the processor 98 to cause the processor to carry out one or more embodiments of the method for conveying ticket validation information (as depicted in FIG. 1 and described in sections of the description above). Furthermore, in at least some examples, the computer readable storage medium may be further embodied with information relating to the public transport vehicle 90, including for example vehicle identification information (such as a vehicle identification number or identification code) and/or associated vehicle route information (such as stop locations and/or stop arrival times comprised as part of the associated route).

The ticket scanning device 96 includes a scanner element 104 for scanning public transport tickets, and a display element 106 for displaying visual output signals, such as written messages, to passengers of the public transport vehicle 90. In example embodiments, the scanner element can include an optical scanning element, such as a barcode scanner or QR code scanner. In other examples, the scanner element may alternatively or in addition include one or more wireless transceiver or sensor elements, such as a near-field-communication transceiver element. The display device may comprise any suitable display such as, by way of non-limiting example, an LCD display, plasma display, CRT display or dot matrix display.

As illustrated in FIG. 6, the processor 98 of the ticket validation system is adapted to be connected with a ticketing system 52, shown, for the purposes of the present example as being the example ticketing system of FIG. 4. In example embodiments, the ticketing system 52 can be a part of the public transport vehicle 90, or may alternatively be a separate, remote system, with which the validation system of the vehicle is in operative communication.

In the example of FIG. 5, the ticket scanning device 96 is shown positioned directly adjacent to an entry/exit door 110 of the public transport vehicle 90. This positioning provides convenient access to passengers directly as the passengers board the vehicle, allowing the passengers to scan a ticket and receive validation information before committing to move further into the vehicle. For example, once the passengers are onboard the vehicle, it may be more difficult to regain access to the entry/exit door 110 to exit the vehicle in the case that the validation information indicates that their ticket is not valid for travel on the vehicle.

In alternative examples, the ticket scanning device may be situated at one or more different locations to the location illustrated in FIG. 4. According to one or more embodiments, the ticket scanning device may be mounted to an outside surface of the vehicle (e.g., mounted adjacent to or in the vicinity of the entry/exit door 110 of the vehicle). Such an embodiment can allow for the ticket validation system 94 to facilitate not only provision of ticket validation information to passengers of the transport system, but also to facilitate an associated validation-based entry system for boarding the train.

Such a variation is not essential according to this embodiment however. An externally-mounted ticket scanning device can provide an advantage of avoiding the build up of congestion at entry points of the vehicle, where passengers can pause as the passengers enter the train in order to scan their ticket and receive validation information. By providing scanning device(s) mounted at point(s) along the outside of the train, passengers can check the validity of tickets for travel on board the vehicle before boarding and avoid obstructing the flow of other passengers boarding and alighting the vehicle.

In the particular example of FIG. 5, the public transport vehicle including the ticket validation system is a train. It will, of course, be appreciated that embodiments of the invention are not limited to application in connection only with trains, but may alternatively include embodiments which comprise any variety of vehicle which is operated as part of a public transport system. Such vehicles may include, by way of non-limiting example, busses, trams, or subway trains.

FIG. 7 depicts computer system 700, which is representative of ticketing system 52 and ticket validation system 94, in accordance with an illustrative embodiment of the present invention. It should be appreciated that FIG. 7 provides only an illustration of one implementation and does not imply any limitations with regard to the environments in which different embodiments may be implemented. Many modifications to the depicted environment may be made. Computer system 700 includes processor(s) 701, cache 703, memory 702, persistent storage 705, communications unit 707, input/output (I/O) interface(s) 706, and communications fabric 704. Communications fabric 704 provides communications between cache 703, memory 702, persistent storage 705, communications unit 707, and input/output (I/O) interface(s) 706. Communications fabric 704 can be implemented with any architecture designed for passing data and/or control information between processors (such as microprocessors, communications and network processors, etc.), system memory, peripheral devices, and any other hardware components within a system. For example, communications fabric 704 can be implemented with one or more buses or a crossbar switch.

Memory 702 and persistent storage 705 are computer readable storage media. In this embodiment, memory 702 includes random access memory (RAM). In general, memory 702 can include any suitable volatile or non-volatile computer readable storage media. Cache 703 is a fast memory that enhances the performance of processor(s) 701 by holding recently accessed data, and data near recently accessed data, from memory 702.

Program instructions and data (e.g., software and data 710) used to practice embodiments of the present invention may be stored in persistent storage 705 and in memory 702 for execution by one or more of the respective processor(s) 701 via cache 703. In an embodiment, persistent storage 705 includes a magnetic hard disk drive. Alternatively, or in addition to a magnetic hard disk drive, persistent storage 705 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 705 may also be removable. For example, a removable hard drive may be used for persistent storage 705. Other examples include optical and magnetic disks, thumb drives, and smart cards that are inserted into a drive for transfer onto another computer readable storage medium that is also part of persistent storage 705. Software and data 710 can be stored in persistent storage 705 for access and/or execution by one or more of the respective processor(s) 701 via cache 703. In various embodiments, software and data 710 can include software programs and/or applications that are capable of performing the operational steps and/or processes of method 12 (depicted in FIG. 1) and method 32 (depicted in FIG. 2).

Communications unit 707, in these examples, provides for communications with other data processing systems or devices. In these examples, communications unit 707 includes one or more network interface cards. Communications unit 707 may provide communications through the use of either or both physical and wireless communications links. Program instructions and data (e.g., software and data 710) used to practice embodiments of the present invention may be downloaded to persistent storage 705 through communications unit 707.

I/O interface(s) 706 allows for input and output of data with other devices that may be connected to each computer system. For example, I/O interface(s) 706 may provide a connection to external device(s) 708, such as a keyboard, a keypad, a touch screen, and/or some other suitable input device. External device(s) 708 can also include portable computer readable storage media, such as, for example, thumb drives, portable optical or magnetic disks, and memory cards. Program instructions and data (e.g., software and data 710) used to practice embodiments of the present invention can be stored on such portable computer readable storage media and can be loaded onto persistent storage 705 via I/O interface(s) 706. I/O interface(s) 706 also connect to display 709.

Display 709 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for ticket validation, the method comprising:
receiving, by one or more processors, ticket identification information that corresponds to a transportation ticket and vehicle identification information that corresponds to a transportation vehicle, wherein the transportation vehicle is associated with a transportation route;
retrieving, by one or more processors, a first data entry that corresponds to the received ticket identification information, wherein the retrieved first data entry includes one or more of: a ticket identification element, a journey start location element, a journey end location element, and a journey valid time-period element;
retrieving, by one or more processors, a second data entry that corresponds to the received vehicle identification information, wherein the retrieved second data entry includes one or more of: information relating to the transportation route associated with the corresponding transportation vehicle, one or more route stop locations along the transportation route, and expected times-of-arrival of the transportation vehicle at the one or more route stop locations;
determining, by one or more processors, whether the transportation ticket is valid for travel along the transportation route associated with the transportation vehicle based on the retrieved first data entry and the retrieved second data entry; and
generating, by one or more processors, an output signal that provides an indication of whether the transportation ticket is valid for travel along the transportation route associated with the transportation vehicle.

2. The method of claim 1, wherein determining whether the transportation ticket is valid for travel along the transportation route associated with the transportation vehicle based on the retrieved first data entry and the retrieved second data entry further comprises:
comparing, by one or more processors, the retrieved first data entry and the retrieved second data to determine whether the journey end location element of the first data entry corresponds to a journey stop location element of the second data entry.

3. The method of claim 1, wherein determining whether the transportation ticket is valid for travel along the transportation route associated with the transportation vehicle based on the retrieved first data entry and the retrieved second data entry further comprises:
comparing, by one or more processors, the journey valid time-period element of the first data entry with a stop arrival time element of the second data entry.

4. The method of claim 1, wherein determining whether the transportation ticket is valid for travel along the transportation route associated with the transportation vehicle based on the retrieved first data entry and the retrieved second data entry further comprises:
determining, by one or more processors, whether one or more additional transportation routes are available that include a journey, within a valid time period associated with the transportation ticket, from a journey start point associated with the transportation ticket to a journey end point associated with the transportation ticket.

5. The method of claim 4, further comprising:
responsive to determining that the one or more additional transportation routes are available, generating, by one or more processors, the output signal to further include information relating to transportation route stops associated with the one or more additional transportation routes are available.

6. The method of claim 1, wherein generating the output signal further comprises:
generating, by one or more processors, an electronic communication signal for transmission to a mobile communication device associated with the transportation ticket.

7. The method of claim 1, wherein the received ticket identification information is received in response to the transportation ticket being scanned at a scanner associated with a transportation vehicle.

8. A computer program product for ticket validation, the computer program product comprising:
one or more computer readable storage media and program instructions stored on the one or more computer readable storage media, the program instructions comprising:
program instructions to receive ticket identification information that corresponds to a transportation ticket and vehicle identification information that corresponds to a transportation vehicle, wherein the transportation vehicle is associated with a transportation route;
program instructions to retrieve a first data entry that corresponds to the received ticket identification information, wherein the retrieved first data entry includes one or more of: a ticket identification element, a journey start location element, a journey end location element, and a journey valid time-period element;
program instructions to retrieve a second data entry that corresponds to the received vehicle identification information, wherein the retrieved second data entry includes one or more of: information relating to the transportation route associated with the corresponding transportation vehicle, one or more route stop locations along the transportation route, and expected times-of-arrival of the transportation vehicle at the one or more route stop locations;
program instructions to determine whether the transportation ticket is valid for travel along the transportation route associated with the transportation vehicle based on the retrieved first data entry and the retrieved second data entry; and
program instructions to generate an output signal that provides an indication of whether the transportation ticket is valid for travel along the transportation route associated with the transportation vehicle.

9. The computer program product of claim 8, wherein the program instructions to determine whether the transportation ticket is valid for travel along the transportation route associated with the transportation vehicle based on the retrieved first data entry and the retrieved second data entry further comprise program instructions to:
compare the retrieved first data entry and the retrieved second data to determine whether the journey end location element of the first data entry corresponds to a journey stop location element of the second data entry.

10. The computer program product of claim 8, wherein the program instructions to determine whether the transportation ticket is valid for travel along the transportation route associated with the transportation vehicle based on the retrieved first data entry and the retrieved second data entry further comprise program instructions to:
compare the journey valid time-period element of the first data entry with a stop arrival time element of the second data entry.

11. The computer program product of claim 8, wherein the program instructions to determine whether the transportation ticket is valid for travel along the transportation route associated with the transportation vehicle based on the retrieved first data entry and the retrieved second data entry further comprise program instructions to:
determine whether one or more additional transportation routes are available that include a journey, within a valid time period associated with the transportation ticket, from a journey start point associated with the transportation ticket to a journey end point associated with the transportation ticket.

12. The computer program product of claim 11, further comprising program instructions, stored on the one or more computer readable storage media, to:
responsive to determining that the one or more additional transportation routes are available, generate the output signal to further include information relating to transportation route stops associated with the one or more additional transportation routes are available.

13. The computer program product of claim 8, wherein the program instructions to generate the output signal further comprise program instructions to:
generate an electronic communication signal for transmission to a mobile communication device associated with the transportation ticket.

14. The computer program product of claim 8, wherein the received ticket identification information is received in response to the transportation ticket being scanned at a scanner associated with a transportation vehicle.

15. A computer system for ticket validation, the computer system comprising:
one or more computer processors;
one or more computer readable storage media; and
program instructions stored on the computer readable storage media for execution by at least one of the one or more processors, the program instructions comprising:
program instructions to receive ticket identification information that corresponds to a transportation ticket and vehicle identification information that corresponds to a transportation vehicle, wherein the transportation vehicle is associated with a transportation route;
program instructions to retrieve a first data entry that corresponds to the received ticket identification information, wherein the retrieved first data entry includes one or more of: a ticket identification element, a journey start location element, a journey end location element, and a journey valid time-period element;
program instructions to retrieve a second data entry that corresponds to the received vehicle identification information, wherein the retrieved second data entry includes one or more of: information relating to the transportation route associated with the corresponding transportation vehicle, one or more route stop locations along the transportation route, and expected times-of-arrival of the transportation vehicle at the one or more route stop locations;
program instructions to determine whether the transportation ticket is valid for travel along the transportation route associated with the transportation vehicle based on the retrieved first data entry and the retrieved second data entry; and
program instructions to generate an output signal that provides an indication of whether the transportation ticket is valid for travel along the transportation route associated with the transportation vehicle.

16. The computer system of claim 15, wherein the program instructions to determine whether the transportation ticket is valid for travel along the transportation route associated with the transportation vehicle based on the retrieved first data entry and the retrieved second data entry further comprise program instructions to:
compare the retrieved first data entry and the retrieved second data to determine whether the journey end location element of the first data entry corresponds to a journey stop location element of the second data entry.

17. The computer system of claim 15, wherein the program instructions to determine whether the transportation ticket is valid for travel along the transportation route associated with the transportation vehicle based on the retrieved first data entry and the retrieved second data entry further comprise program instructions to:
compare the journey valid time-period element of the first data entry with a stop arrival time element of the second data entry.

18. The computer system of claim 15, wherein the program instructions to determine whether the transportation ticket is valid for travel along the transportation route associated with the transportation vehicle based on the retrieved first data entry and the retrieved second data entry further comprise program instructions to:
determine whether one or more additional transportation routes are available that include a journey, within a valid time period associated with the transportation ticket, from a journey start point associated with the transportation ticket to a journey end point associated with the transportation ticket.

19. The computer program product of claim 18, further comprising program instructions, stored on the computer readable storage media for execution by at least one of the one or more processors, to:
responsive to determining that the one or more additional transportation routes are available, generate the output signal to further include information relating to transportation route stops associated with the one or more additional transportation routes are available.

20. The computer program product of claim 15, wherein the program instructions to generate the output signal further comprise program instructions to:
generate an electronic communication signal for transmission to a mobile communication device associated with the transportation ticket.
